(19) United States
(12) Patent Application Publication
(10) Pub. No.: US 2025/0068845 A1
(43) Pub. Date: Feb. 27, 2025

(54) DATA EXTRACTION FROM PRINTED DOCUMENTS

(71) Applicant: Royal Bank of Canada, Toronto (CA)

(72) Inventors: Tirthkumar PATEL, Ajax (CA); Avelyn WONG, Toronto (CA); Kashish Trusharkumar MISTRY, Toronto (CA)

(21) Appl. No.: 18/792,282

(22) Filed: Aug. 1, 2024

Related U.S. Application Data
(60) Provisional application No. 63/534,214, filed on Aug. 23, 2023.

(51) Int. Cl. G06F 40/279; G06V 30/10; G06V 30/412

(52) U.S. Cl. CPC G06F 40/279; G06V 30/10; G06V 30/412

(57) ABSTRACT

A computer-implemented method for extracting data from printed documents comprises receiving a printed document and identifying the printed document as one of a structured form (including fully structured and semi-structured) and an unstructured form. Where the printed document is identified as a structured form, the method identifies first text features corresponding to keys for key-value pairs and identifies second text features that satisfy a proximity threshold (and optionally one or more key constraints) relative to the respective first text feature as the respective values of the respective key-value pairs, and records the values of the key-value pairs. Where the printed document is identified as a semi-structured form, the method may further comprise identifying at least one unstructured portion of the printed document and applying a trained machine learning model to the unstructured portion of the printed document to obtain additional values for additional key-value pairs.

### CROSS-REFERENCE TO RELATED APPLICATION

This application claims the benefit of U.S. Provisional Application No. 63/534,214 filed on Aug. 23, 2023, the teachings of which are hereby incorporated by reference.

### TECHNICAL FIELD

The present disclosure relates to data extraction, and more particularly to data extraction from printed documents.

### BACKGROUND

There are a range of existing technologies for extracting data from forms and other documents. For example, machine learning approaches have been deployed, but many of these do not generalize well to document types that the supporting models have not encountered before.

Template-based approaches have also been used. In a template-based approach, a printed document (which can include an electronic file representing a printed document) is received and identified as one of a structured form and an unstructured form. Where the printed document is identified as a structured form (e.g. a completed copy of a particular type of tax form), a corresponding template type of the structured form is identified (e.g. a blank copy of that tax form), which indicates the target value field locations on the form where data is expected. These target value field locations are used to identify target coordinates on the printed document, and then text can be extracted from the printed document at the target coordinates. However, template-based approaches require pre-existing knowledge of the relevant templates, and are again ineffective with novel document types.

### SUMMARY

In one aspect, a computer-implemented method for extracting data from printed documents is described. The method comprises receiving a printed document and identifying the printed document as one of a structured form and an unstructured form. Where the printed document is identified as a structured form, the method identifies a first text feature within the printed document corresponding to a key for a key-value pair, and identifies, as a value of the key-value pair, a second text feature within the printed document that satisfies both a proximity threshold relative to the first text feature and at least one key constraint relative to the first text feature. The method then records the value of the key-value pair.

The method may further comprise determining a confidence level for the value of the key-value pair.

In one embodiment, the second text feature satisfies the proximity threshold and key constraint(s) relative to the first text feature when the second text feature is horizontally proximal to the first text feature, the second text feature satisfies the key constraint(s) and a number of discarded text features that are horizontally proximal to the first text feature and closer to the first text feature than the second text feature is to the first text feature is less than a predetermined maximum. The discarded text features are those that were discarded for failing to satisfy the key constraint(s).

In one embodiment, the second text feature satisfies the proximity threshold and the key constraint(s) relative to the first text feature when the second text feature is vertically proximal to the first text feature, the second text feature satisfies the key constraint(s) and a number of discarded text features that are vertically proximal to the first text feature and closer to the first text feature than the second text feature is to the first text feature is less than a predetermined maximum. The discarded text features are those that were discarded for failing to satisfy the key constraint(s).

In one embodiment, the second text feature satisfies the proximity threshold and the key constraint(s) relative to the first text feature when the second text feature is within a common boundary with the first text feature, the second text feature satisfies the key constraint(s) and a number of discarded text features that are within a common boundary with the first text feature and closer to the first text feature than the second text feature is to the first text feature is less than a predetermined maximum. The discarded text features are those that were discarded for failing to satisfy the key constraint(s).

The method may further comprise, prior to identifying the second text feature, performing optical character recognition (OCR) on at least a portion of the printed document, which may be carried out prior to identifying the first text feature.

The method may further comprise, prior to identifying the second text feature, identifying a document type for the printed document and superimposing a virtual document template matching the document type on the printed document. In such an embodiment, the virtual document template includes an opaque region corresponding to at least the first text feature, wherein the opaque region is in superposition with the first text feature, and a transparent region, wherein the transparent region is in superposition with an expected location of the second text feature. The second text feature satisfies the proximity threshold relative to the first text feature when the second text feature is within the transparent region and is unobscured by the virtual document template. This embodiment of the method may further comprise, prior to identifying the second text feature, performing OCR on at least a portion of the printed document to identify characters of the second text feature.

The method may further comprise, responsive to identifying the printed document as an unstructured form, applying a trained machine learning model to content of the printed document to extract the value for the key-value pair. The trained machine learning model may be a large language model. The content of the printed document may be obtained by, prior to applying the trained machine learning model, performing OCR on at least a portion of the printed document.

The method may further comprise, responsive to identifying the printed document as a structured form, identifying the printed document as one of a fully structured form or a semi-structured form. In such an embodiment, responsive to identifying the printed document as a semi-structured form, the method may identify at least one unstructured portion of the printed document and apply a trained machine learning model to the unstructured portion of the printed document.

In another aspect, another computer-implemented method for extracting data from printed documents is described. The method comprises receiving a printed document and identifying the printed document as one of a structured form and an unstructured form. Where the printed document is identified as a structured form, the method identifies a first text feature within the printed document corresponding to a key for a key-value pair, identifies, as a potential value of the key-value pair, a second text feature within the printed document that satisfies a proximity threshold relative to the first text feature, and records the potential value of the key-value pair.

In one embodiment, the proximity threshold is that the second text feature is one of a plurality of candidate text features that is closest to the first text feature.

In some embodiments, the second text feature is identified as the potential value of the key-value pair solely because the second text feature satisfies the proximity threshold.

In other embodiments, the second text feature is identified as the potential value of the key-value pair because the second text feature is the closest one of a plurality of candidate text features that satisfies at least one key constraint.

In yet further aspects, the present disclosure describes data processing systems and computer program products for implementing the above-described methods.

### BRIEF DESCRIPTION OF THE DRAWINGS

These and other features will become more apparent from the following description in which reference is made to the appended drawings wherein:

FIG. 1 shows a computer network that comprises an example embodiment of a system for extracting data from printed documents;

FIG. 2 depicts an example embodiment of a server in a data center;

FIG. 3 is a flow chart showing a first illustrative method for extracting data from printed documents;

FIG. 3A is a flow chart showing a second illustrative method for extracting data from printed documents;

FIG. 4 shows a section of an illustrative printed document;

FIG. 5 is a flow chart showing a first illustrative method for applying a positional algorithm to identify a second text feature in a printed document that satisfies a proximity threshold relative to a first text feature;

FIG. 5A is a flow chart showing a second illustrative method for applying a positional algorithm to identify a second text feature in a printed document that satisfies a proximity threshold relative to a first text feature;

FIG. 6 schematically illustrates the use of a virtual template to identify a second text feature in a printed document that satisfies a proximity threshold relative to a first text feature;

FIG. 7 is a flow chart showing an illustrative method for determining confidence levels for returned values for key-value pairs;

FIG. 8 shows a first screen of an illustrative user interface for a system according to an aspect of the present disclosure;

FIG. 9 shows a second screen of an illustrative user interface for a system according to an aspect of the present disclosure;

FIG. 10 shows an illustrative technical architecture for an implementation of a system for extracting data from printed documents; and

FIG. 11 shows an illustrative system data flow diagram for a system for extracting data from printed documents.

### DETAILED DESCRIPTION

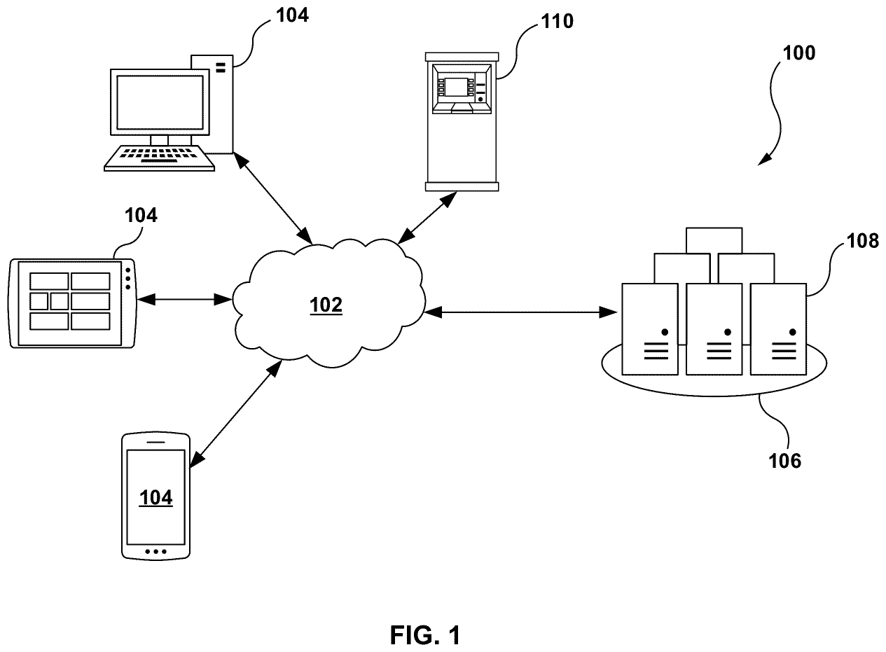

Referring now to FIG. 1, there is shown a computer network 100 that comprises an example embodiment of a system for extracting data from printed documents. More particularly, the computer network 100 comprises a wide area network 102 such as the Internet to which various client devices 104, an automated teller machine (ATM) 110, and data center 106 are communicatively coupled. The data center 106 comprises a number of servers 108 networked together to collectively perform various computing functions. For example, in the context of a financial institution such as a bank, the data center 106 may host online banking services that permit clients to log in to those servers using client accounts that give them access to various computer-implemented banking services, such as online fund transfers; the clients may also be provided with access to e-mail services and/or various types of content. Furthermore, individuals may appear in person at the ATM 110 to withdraw money from bank accounts controlled by the data center 106. One or more of the servers 108 may implement a method for extracting data from printed documents; clients may submit the printed documents in electronic form using the client devices 104. The ATM 110 may include a document scanner to scan a physical printed document and generate an electronic copy thereof. The printed documents may be stored on servers 108 in the data center 106, or elsewhere. Thus, the term “printed document” includes an electronic file representing a physical paper version of a document, for example an image file or a Portable Document Format (PDF) file, and this is the case even where the document was originally generated in electronic form and no paper version ever existed. Moreover, the electronic file may include American Standard Code for Information Interchange (ASCII) or similar text, such as an electronic form with fillable fields, embedded text (e.g. scanned optical character recognition (OCR) text), or merely images representing text (handwritten and/or printed) that may later be subjected to OCR. In addition, a printed document may include some text that is in a formal font or typeface (e.g. computer generated or typed on an old-school mechanical typewriter) and other text that is handwritten, such as a form with questions in a formal typeface but where the answers are to be written in by hand.

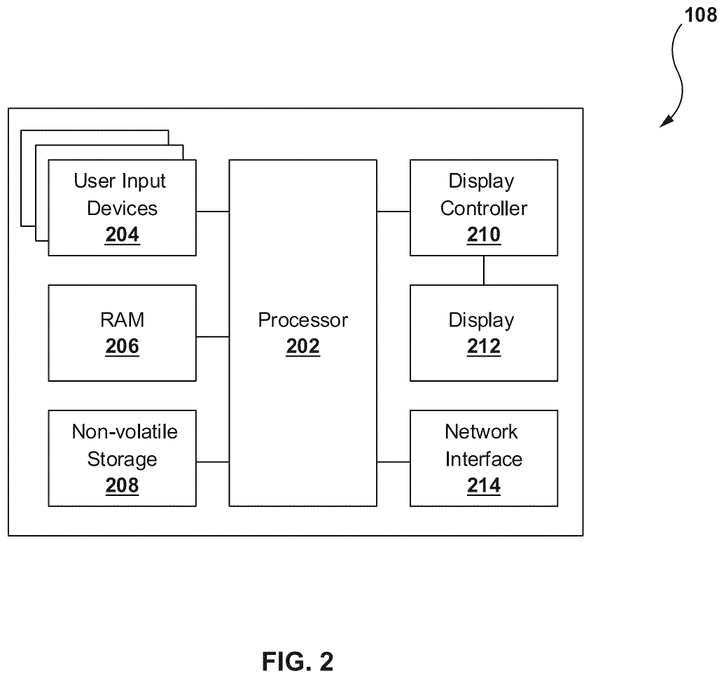

Referring now to FIG. 2, there is depicted an example embodiment of one of the servers 108 that comprises the data center 106. The server comprises a processor 202 that controls the overall operation of the server 108. The processor 202 is communicatively coupled to and controls several subsystems. These subsystems comprise input devices 204, which may comprise, for example, any one or more of a keyboard, mouse, touch screen, voice control; random access memory (“RAM”) 206, which stores computer program code for execution at runtime by the processor 202; non-volatile storage 208, which stores the computer program code executed by the processor 202 at runtime; a display controller 210, which is communicatively coupled to and controls a display 212; and a network interface 214, which facilitates network communications with the wide area network 102 and the other servers 108 in the data center 106. The non-volatile storage 208 has stored on it computer program code that is loaded into the RAM 206 at runtime and that is executable by the processor 202. When the computer program code is executed by the processor 202, the processor 202 causes the server 108 to implement methods for extracting data from printed documents as described in more detail below. Additionally or alternatively, the servers 108 may collectively perform that method using distributed computing. While the system depicted in FIG. 2 is described specifically in respect of one of the servers 108, analogous versions of the system may also be used for the client devices 104.

Broadly speaking, the present disclosure describes a system that uses both positional algorithms and a large language model (LLM) to extract data from a variety of printed documents that can be structured (including fully structured and semi-structured), or unstructured. The combination of positional and contextual information helps extract values from printed documents with a high level of confidence.

The present disclosure will describe illustrative systems and methods for extracting data from printed documents in the context of financial services, such as applications for loans (e.g. mortgage loans, car loans, personal loans) in which the printed documents relate to an individual's financial circumstances and creditworthiness (e.g. tax forms, letters of employment). However, this is merely an illustrative context in which the technical features may be applied, and the present disclosure is not directed to any financial or economic system or method. The systems and methods for extracting data from printed documents as described herein may be applied in a wide range of other contexts, including without limitation the following:
Employment (documents may include resumes, application forms, reference letters, etc.)
Insurance (documents may include claim forms, invoices, estimates, accident reports, medical reports, etc.)
Business materials (documents may include financial statements, earnings projections, etc.)

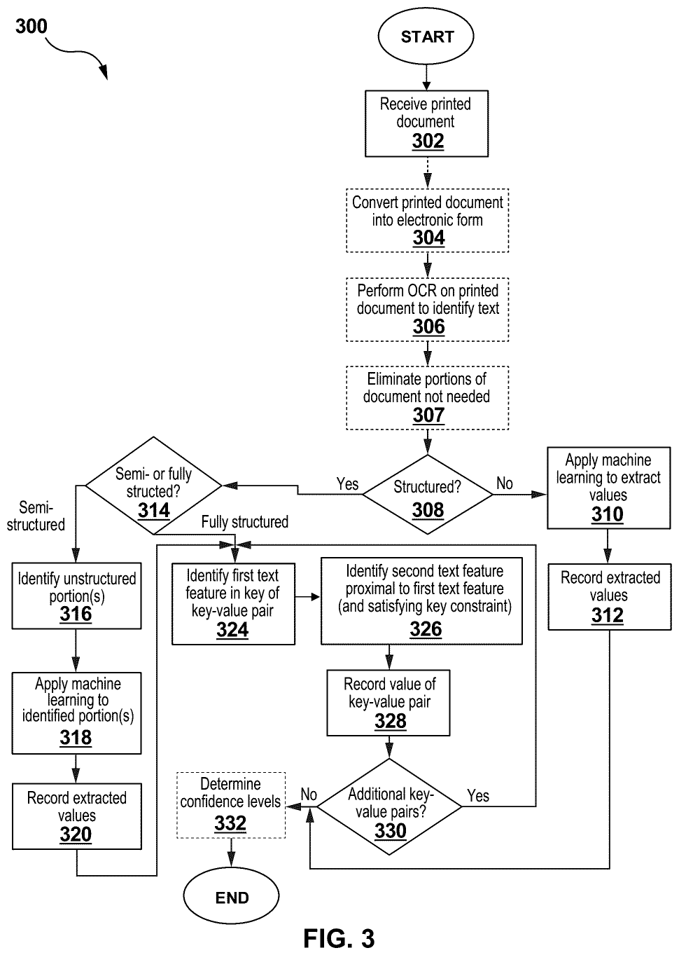

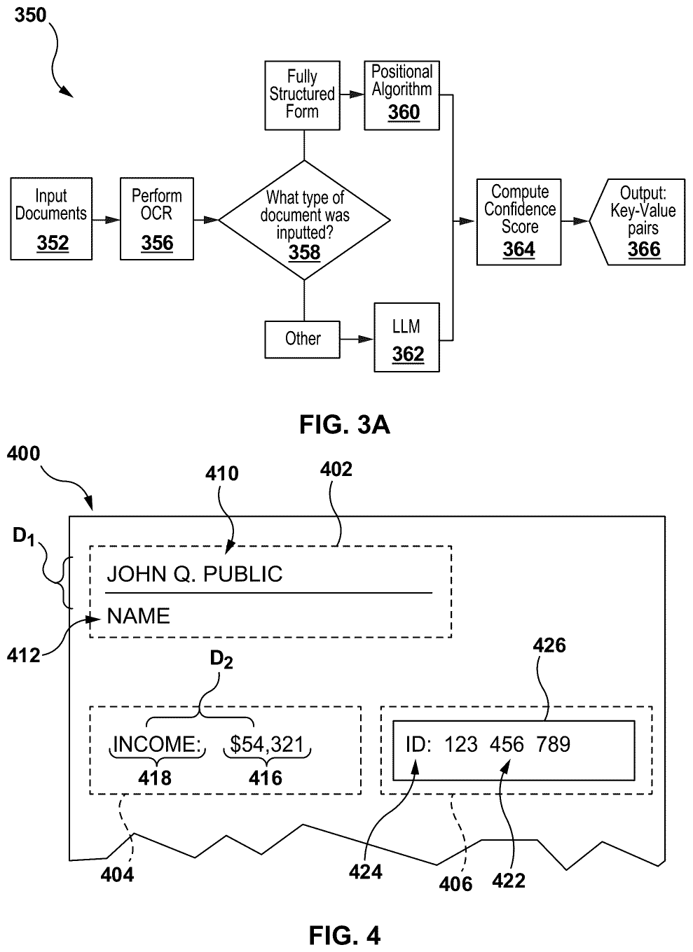

Reference is now made to FIG. 3, which shows an illustrative, non-limiting embodiment of a computer-implemented method 300 for extracting data from printed documents. Broadly speaking, the data extracted by the method 300 comprises the data used to populate the value of a key-value pair. In one example, the key may be “FIRST NAME” and the value may be an individual's first (given) name. In another example, the key may be “INCOME” and the value may be “$54,321”. These are merely non-limiting illustrative examples.

At step 302, the method 300 receives a printed document. As noted above, the term “printed document” includes an electronic file representing a physical paper version of a document. The printed document may originally be created in electronic form, may be converted from one electronic form to another (e.g. a .DOC file may be converted to a .PDF file) or may begin as a paper form that is filled in and then scanned or photographed to generate an electronic document. A printed document may also be created in electronic form, printed onto paper, and then the paper form may be scanned to create another electronic version. Where the printed document is received at step 302 as a paper form, at optional step 304 the method 300 converts the printed document into electronic form. For example a paper document may be placed upon or fed through a scanner, or may be photographed to generate an image file.

After step 302 and, if necessary, step 304, the printed document will be in an electronic format suitable for computer analysis.

At optional step 306, the method 300 performs OCR on at least a portion of the printed document to identify text in the printed document. Step 306 may be omitted, for example, if the printed document is received with all text already identified, for example in the case of a fillable electronic form, or a document on which OCR was already performed. In some embodiments, the step of performing OCR on at least a portion of the printed document to identify text in the printed document can be performed at later stages of the method.

In a presently preferred embodiment, the printed documents are received as PDF files, although other file formats are also contemplated, including without limitation Joint Photographic Experts Group (JPEG), Portable Network Graphics (PNG), Bitmap (BMP), and Tag Image File Format (TIFF) file formats. The printed document files then undergo OCR processing (which may include conversion from one file format into a different file format that is readable by the OCR software). In a presently preferred embodiment, the printed documents are converted into JavaScript Object Notation (JSON) file format containing lines of recognized text on the printed document and the page numbers and bounding boxes for each line of text and each word. In one implementation, the Azure Read API may be used to obtain the JSON versions of the printed documents. The Azure Read API is part of the Azure AI product offering from Microsoft Corporation, having an address at One Microsoft Way, Redmond, Washington 98052-6399. Other software tools may be used to obtain the JSON versions of the printed documents (file formats other than JSON may be used). The JSON versions of the printed documents can then be stored in a database, for example a PostgreSQL database. PostgreSQL is an open source object-relational database system (https://www.postgresql.org/) and is merely an illustrative, non-limiting example. In some cases, image preprocessing may be performed on the printed documents; where the printed documents are received (or scanned, or otherwise converted to PDF format) the files may need to be converted to an image format to facilitate such image preprocessing.

At optional step 307, the method 300 may eliminate some portions (e.g. pages or paragraphs) of the printed document that will not be needed for subsequent processing. Irrelevant or unnecessary portions of the document can be filtered out by removing them from the JSON file returned by the OCR engine based on section titles or other text content. This filtering step would require that the specific type of document be known. For example, different types of documents may have common “boilerplate” text that can be filtered out simply by identifying that text, without knowing the nature of the specific document.

At step 308, the method 300 identifies the printed document as one of a structured form (including fully structured and semi-structured) or an unstructured form.

A fully structured form is one in which there is a 1:1 positional association between keys and values for a given key-value pair, and the key and associated value are in relative proximity to one another. In addition to tax forms, other examples of structured forms include certain types of surveys, tests, and claim forms (e.g. insurance or health benefits).

An unstructured form is one that does not have a set structure. Examples include letters (e.g. letter of employment), contracts (e.g. an employment contract), news or journal articles, and memoranda.

A semi-structured form is one that includes at least one structured portion, that is, a portion having a 1:1 association between keys and values for a given key-value pair, and at least one unstructured portion. For example, a job application may include a structured portion where an applicant provides basic biographical information, such as their name, street address, city, state/province, zip/postal code, etc. in specific locations and then an unstructured portion for information such as employment history, training and experience, biographical information, and the like. In a Canadian T4 tax form, for example, there is a structured portion containing individual boxes for financial information including employment income, income tax deducted, and other amounts (1:1 correspondence), but the entire address of the individual is situated within a single text box without a 1:1 positional association between individual keys (street address, city, province, postal code) and the associated values. Thus, an unstructured form, or an unstructured portion of a form, may still have some structure (e.g. the address is within a visibly bounded box) but lacks 1:1 positional association between individual keys (e.g. the city, province or postal code may not always be on the same line, depending on whether the street address occupies more than one line, for example including a building name as well as a street address).

Of note, at step 308 the method 300 does not necessarily identify a specific type of form or template (e.g. Form 1040, Form W-2, Form T4, Form T5, etc.), but rather identifies whether the form is structured (i.e. includes at least one structured portion) or unstructured. While this step may involve identifying the specific type of document, it need not do so. Step 308 may be carried out in a variety of ways. In one embodiment, an individual submitting the printed document can identify it as structured (including semi-structured) or unstructured, either explicitly or implicitly (i.e. specifying the type of printed document may inherently identify it as being structured or unstructured). Preferably, however, a computer system implementing the method 300 automatically identifies the form as structured or unstructured. For example, the method 300 can implement a trained machine learning classifier (e.g. using a library of known forms), or deploy feature identification (for example, rectangles with single lines of text will typically indicate a structured form). Notably, at step 308 a semi-structured form is considered to be a structured form because it has structured form features; step 308 distinguishes between the set consisting of structured forms (including both fully structured forms and semi-structured forms), on the one hand, and unstructured forms, on the other hand. Distinguishing between fully structured forms and semi-structured forms is handled at step 314 as described below.

Responsive to identifying the printed document as an unstructured form at step 308, the method 300 proceeds to step 310 to apply a trained machine learning model to content of the printed document to extract values for corresponding key-value pairs. The trained machine learning model is preferably a large language model (LLM), although other suitable machine learning models may also be used. In one non-limiting example, the LLM is the Falcon 40B LLM offered by Technology Innovation Institute having an address at P.O. Box 9639, Yas Island, Abu Dhabi, United Arab Emirates and may be hosted, for example, on Amazon SageMaker offered by Amazon Web Services, Inc. having an address at 410 Terry Avenue North, Seattle, Washington, 98109-5210. Other LLMs may be used. For documents (or portions of documents-see steps 316 to 320 discussed below) where the value text for a key-value pair is not in close proximity to the corresponding key text, or values are stated without keys (e.g. in a letter of employment, paystub, etc.), the use of a LLM is advantageous for contextual understanding and association of key-value pairs.

In an embodiment in which the printed document is represented using the JSON file format, the JSON data for the text is retrieved and sent to the LLM, along with one or more suitable prompts. Preferably, the prompts are predefined prompts engineered for optimal LLM responses. The prompts are called in succession to the LLM for each field (key-value pair) required from the text.

In one embodiment, for each document that is sent to the LLM, the following prompts are used (this is merely an illustrative example and is not limiting):
1. “You are a helpful assistant that extracts information from [document name] and returns JSON key-value pairs.”
2. “Here is the text from a [document name]: [OCR text].”
3. “Extract only the [value] in the form [format] from the [document name] and return the key-value pair in JSON format. The key should be [key]. If the [value] does not exist, the value should be null.”

The first prompt is used to ensure that the LLM has context for what its task is during that conversation and so that it can understand the format of that document. The third prompt is repeated for each key-value pair to extract the respective values. Thus, step 310 may comprise a series of sub-steps until all key-value pairs have been queried. The results are returned in JSON format for ease of use in the backend and the request to return NULL for the absence of a field is used to prevent hallucinations by the LLM.

In a preferred embodiment, Chain-of-Thought (CoT) Prompting methodology is used for prompt design to help the LLM gain context for each document before prompting it to extract fields. CoT Prompting methodology is described in the publication Chain-of-Thought Prompting Elicits Reasoning in Large Language Models by Jason Wei, Xuezhi Wang, Dale Schuurmans, Maarten Bosma, Brian Ichter, Fei Xia, Ed Chi, Quoc Le, and Denny Zhou, arXiv: 2201.11903v6, published at https://arxiv.org/abs/2201.11903 and incorporated herein by reference in its entirety. Broadly speaking, CoT Prompting methodology is an approach in which the prompts submitted to a large language model include demonstrations of reasoning (“chains of thought”) as examples.

After extracting the values, the values are recorded at step 312, after which the method 300 proceeds to optional step 332. Alternatively, each of the values may be recorded as it is extracted; i.e. step 312 may be subsumed into step 310. Where optional step 306 is performed prior to step 308, the content of the printed document will have been obtained by performing OCR on the printed document prior to applying the trained machine learning model. Alternatively, for example, the OCR step may be performed between steps 308 and 310.

Responsive to determining at step 308 that the printed document is a structured form, the method 300 proceeds to step 314 to determine whether the printed document is a fully structured form or a semi-structured form. Distinguishing between a fully structured form and a semi-structured form can be performed using similar techniques to those at step 308 (e.g. a trained machine learning classifier, or feature identification), and/or by determining that more than a threshold amount of the printed document lacks indicia of a fully structured form.

If at step 314 the method 300 identifies the printed document as a semi-structured form, the method 300 proceeds to step 316 to identify at least one unstructured portion of the printed document. Depending on the document type, image preprocessing may be performed to isolate the unstructured portion of the printed document. For example, in a Canadian T4 tax form, the address of the individual is situated within a single visibly bounded text box without a 1:1 positional association between keys and values for the individual components of the address (street address, city, province, postal code). In this scenario, image preprocessing may be used to identify visibly bounded text boxes by extracting all of the rectangular contours on the printed document and identifying the visibly bounded text box containing the phrase ‘name and address’ using the coordinates of the lines of text in the JSON document (e.g. as returned by the OCR engine) and the vertices of the rectangular contours. Tools from the OpenCV library, available at https://opencv.org/releases/and incorporated herein by reference, may be used for image preprocessing; other suitable tools may also be used. Subsequently, the section of text within the text box would be used as input to the LLM.

The method then proceeds to step 318 to apply a trained machine learning model to the unstructured portion(s) of the printed document. For example, the text within the visibly bounded text box containing the phrase ‘name and address’ may be subjected to the machine learning model. The trained machine learning model applied at step 318 may be the same trained machine learning model applied at step 310, or a different model. Where OCR has not been applied to the unstructured portion of the printed document at optional step 306, this may be done, for example, between steps 316 and 318. In one preferred embodiment, at step 318 the trained machine learning model is queried for all key-value pairs; some of these may be returned as NULL if the values are not present in the unstructured portion of the printed document. Thus, step 318 may comprise a series of sub-steps until all key-value pairs have been queried. After step 318, the method proceeds to step 320 to record the extracted values. Alternatively, each of the values may be recorded as it is extracted; i.e. step 320 may be subsumed into step 318. Steps 314 to 320 may be omitted if the method 300 is not expected to encounter semi-structured forms, or where only the data in the structured portion of a semi-structured form needs to be extracted.

Responsive to identifying the printed document as a structured form at step 308 where optional steps 314 to 320 are absent, or, where optional steps 314 to 320 are present, responsive to identifying the printed document as a fully structured form at step 314, or after step 320 if the printed document is identified as a semi-structured form at step 314, the method 300 proceeds to step 324.

At step 324, the method 300 identifies a first text feature within the printed document corresponding to a key for a corresponding key-value pair. Where optional step 306 is present, OCR will have been performed on at least a portion of the printed document prior to identifying the first text feature 324; alternatively OCR may be performed at other stages prior to step 324. In some embodiments, OCR may not be necessary for step 324 to be carried out, for example if the printed document is a form containing ASCII or similar recognizable coded characters.

After step 324, the method 300 proceeds to step 326 to identify a second text feature within the printed document that satisfies both a proximity threshold (as described below) and one or more key constraints relative to the first text feature as the value of the key-value pair. A “key constraint” is a check performed prior to returning the key-value pair to eliminate values that are nonsensical, given the nature of the key, from the list of values in close proximity to the key. For example, a name key (e.g. “first name” or “last name”) should contain alphabetical characters only and a value containing a number may be eliminated. Similarly, the value for a numerical key (e.g. “salary”) should not contain a letter.

In an alternative embodiment, step 326 may test only whether the second text feature satisfies a proximity threshold, and testing for whether the second text feature satisfies the key constraint(s) may be deferred, subsumed into a later process (e.g. the method 700 described below), or omitted entirely. For example, in some embodiments a proximity threshold may be satisfied where the second text feature is a closest one of one or more candidate features that is less than a predetermined distance from the first text feature, or simply where the second text feature is a closest one of one or more candidate features.

At step 328, the method records the value of the key-value pair. Optional post-processing steps may be performed on the value of the key-value pair before recording it, depending on the nature of the field to which the key-value pair relates. For example, vertical lines extracted by the OCR engine as ‘|’ may be removed, and monetary values may be converted to float types after ‘$’, ‘€’, ‘£’, and ‘,’ characters are removed. Also optionally, a currency conversion into a local currency may be applied. The foregoing optional post-processing steps can also be performed after recording.

At step 330, the method 300 checks whether there are additional key-value pairs for which values have yet to be obtained. If so (“yes” at step 330), the method 300 returns to step 324. If no, the method proceeds to optional step 332 to define confidence levels for the values, as described further below. It is noted that in an alternate embodiment, rather than obtaining the key-value pairs one at a time as shown by steps 324 through 330, the system may make a single pass through the structured portion of the printed document to obtain all of the values for the key-value pairs. It is also noted that steps 316 through 320 (obtaining values from unstructured portions of the printed document) may alternatively take place after all cycles of steps 324 to 330 are complete, or substantially simultaneously therewith.

FIG. 3A shows a simplified method 350 in which the printed document is identified as either a fully structured form, or an “other” type of form (semi-structured or unstructured). At step 352, a printed document is input into the system (analogously to steps 302 and 304 as described with respect to FIG. 3). At step 356, OCR is performed on the printed document, analogously to step 306 as described above. At step 358, the method 350 identifies the printed document as either a fully structured form, or an “other” document (semi-structured form or unstructured form). Responsive to identifying the printed document as a fully structured form at step 358, the method 350 proceeds to step 360 to use a positional algorithm to identify the value(s) for the target key-value pair(s). Responsive to identifying the printed document as an “other” document at step 358, the method 350 proceeds to step 362 to use an LLM to obtain the value(s) for the target key-value pair(s), analogously to steps 310 and 318 of the method 300 shown in FIG. 3. After either step 360 or 362, the method 350 proceeds to step 364 to compute the confidence score, analogously to step 332 in FIG. 3, and then to step 366 to output the key-value pairs along with the confidence scores.

There are a number of techniques that may be used to implement steps 324 and 326 in the method 300, and step 360 in the method 350 shown in FIG. 3A.

In one embodiment, the first text feature corresponding to the key of a particular key-value pair may be identified by searching for text indicative of the key of the key-value pair. For example, a computer system implementing the method 300 may search for the term “NAME” or “INCOME”. The system may also identify synonyms or related terms as indicative of the key of the key-value pair. For example, if the key is “INCOME” the system may identify the word “salary” as indicative of the key “INCOME”.

Once the first text feature corresponding to the key of a particular key-value pair has been identified at step 324, a positional algorithm may be used, in which the second text feature representing the value is identified based on proximity, that is, whether the second text feature satisfies a proximity threshold relative to the first text feature. Testing whether the second text feature satisfies the proximity threshold relative to the first text feature can be performed by testing whether the second text feature is horizontally proximal to the first text feature, or whether the second text feature is vertically proximal to the first text feature. In one embodiment, the proximity threshold comprises a maximum number. In this embodiment, step 326 begins with the closest text feature and tests whether that text feature satisfies the relevant key constraint(s). If that text feature fails to satisfy the relevant key constraint(s), the next closest text feature is tested against the key constraint(s), and so on up to the maximum number. If all of the closest text features within the maximum number fail to satisfy the relevant key constraint(s), then step 326 will return NULL. Otherwise, step 326 will return the first (closest) text feature in the list of potential values that satisfies the key constraint(s). Using a positional algorithm, the second text feature may also satisfy the proximity threshold relative to the first text feature when the second text feature and the first text feature are disposed within a common boundary.

FIG. 4 shows a section of a printed document 400 which includes a first portion 402, a second portion 404 and a third portion 406. In the first portion 402, the second text feature 410 (“John Q. Public”) is vertically adjacent to the first text feature 412 (“NAME”) within a specified distance D1. In the second portion 404, the second text feature 416 (“$54,321”) is horizontally adjacent to the first text feature 418 (“INCOME:”) within a specified distance D2. In the third portion 406, the second text feature 422 (“123 456 789”) and the first text feature 424 (“ID”) are disposed within a common boundary, in this case a rectangle 426. A common boundary may have other shapes as well, including regular and irregular polygons, and curved shapes.

In one illustrative embodiment for testing whether the second text feature is horizontally adjacent or vertically adjacent to the first text feature, the following procedure may be used. Where the file containing the printed document is in JSON format, it will include lines of text as well as bounding boxes surrounding the text (e.g. obtain “chunks” of text and use the four corners as coordinates). To approximate the location of each line of text on the printed document, the centroid of each bounding box is calculated. To find the location on the printed document of a field expected to contain data for a key-value pair, the lines of text are searched to locate the line containing the text indicative of the key of the key-value pair (referred to as “key text”). The centroid for this key text (which may be the key itself or a synonym, as noted above) is then retrieved. Potential values corresponding to the key are retrieved based on their proximity to the centroid of the key text. In preferred embodiments, a modified version of the Euclidean distance formula is used to search for text (“value text”) beside, above or below the key text and calculate the distance between the key text centroid and the value text centroid.

For searching above and below the key text, large x-distances (horizontal distances) are penalized by applying a weight of 0.5 to reduce the impact of these distances:

$$d = \sqrt{0.5 \times {( \vert {key}_{x} - {value}_{x} \vert )}^{2} + {( \vert {key}_{y} - {value}_{y} \vert )}^{2}}$$

The use of the penalty weight ensures that value text lines containing multiple words (thus, having a right-shifted centroid) are still closely associated with the key text above or below. Penalty values other than 0.5 may also be used.

For searching beside the key text (left or right side), only the y-distances (vertical distances) are considered:

$$d = \vert {key}_{y} - {value}_{y} \vert$$

In one embodiment, the value texts are sorted based on increasing distance from the key text centroid, and the value text that is closest to the key text is then identified as the potential value of the key-value pair, subject to later testing for satisfaction of key constraint(s) and/or confidence level.

In another embodiment, the value texts are sorted based on increasing distance from the key text centroid, but only the closest of the value texts to the key text that also satisfies the key constraint(s) is identified as the value of the key-value pair.

In yet another embodiment, the value text satisfying the key constraint(s) that is closest to the key text is identified as the value of the key-value pair only where the number of value texts eliminated for failure to satisfy the key constraint(s) has not reached the maximum. If the predetermined maximum number of value text eliminations is reached, a NULL result is returned.

The use of a maximum number of value text eliminations is a proxy for distance; it implies that there is no value text satisfying the key constraint(s) that is sufficiently close to the key text. In some alternate embodiments, a more direct measure of distance may be used, and a NULL result will be returned where the closest value text to the key text, or the closest value text that satisfies the key constraint(s), is further from the key text than a specified distance (using the distance calculation methods noted above). Alternative distance measures are also contemplated, such as a number of lines of text, a number of characters, a number of words, or a virtual document distance obtained from a document image.

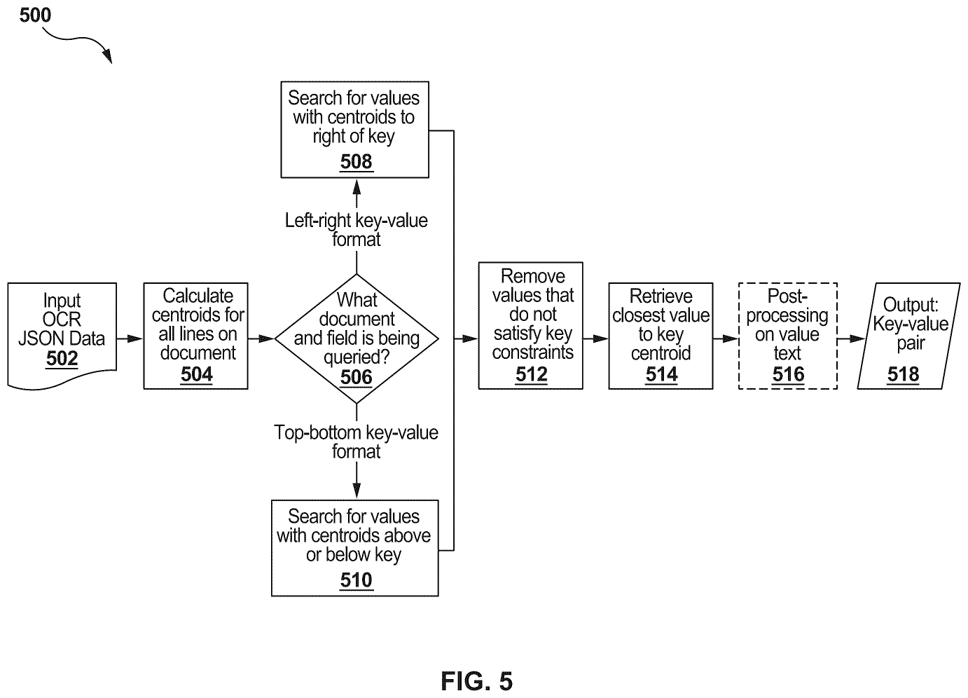

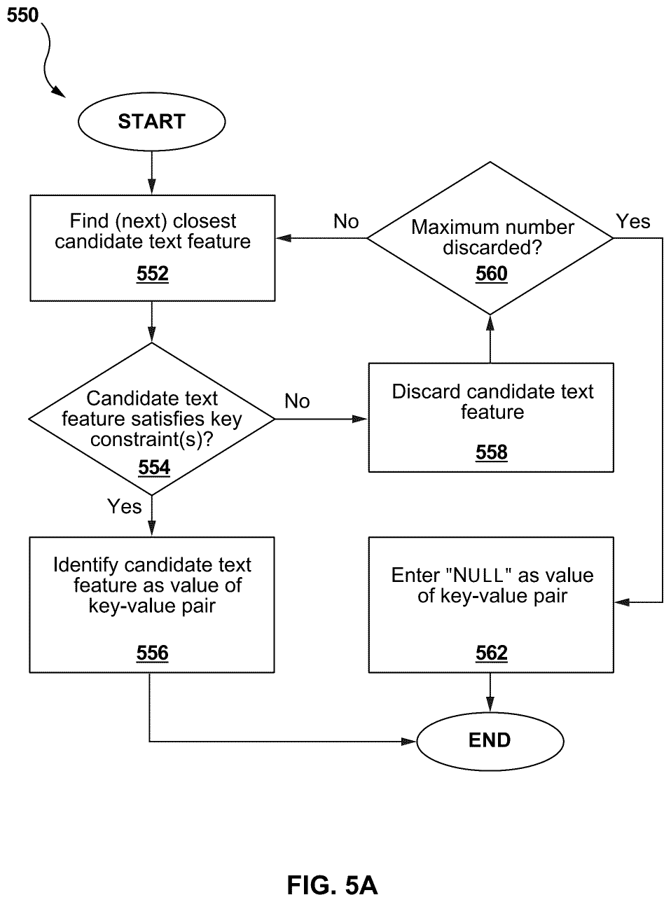

Reference is now made to FIG. 5, which is a flow chart showing a first non-limiting illustrative method 500 for applying a positional algorithm to implement steps 324 and 326.

At step 502, the method 500 receives the printed document (or at least the fully structured form portion thereof) in JSON format (e.g. from step 306 of the method 300 in FIG. 3) and then proceeds to step 504 to calculate the centroids for all lines on the printed document. The method 500 then proceeds to step 506 to determine the document and field (key-value pair) being queried. For example, the document may be explicitly identified at the time of submission (e.g. with a checkbox or a pull-down menu), or may be identified using an image of the document and a trained image classifier, or by identifying signature text elements within the document. Once the document type is known, the key text to be searched, and the order in which to search, can be applied deterministically, for example. As long as all required key-value pairs are searched, the order of the search is not of particular importance. Key-value pairs can be searched, for example, in a fixed order or a random order for a given document type. The method 500 then proceeds to step 508 and/or step 510, depending on the results at step 506. At step 508, the method 500 will search for value texts whose centroids are to the right (or occasionally to the left) of the key text for the desired key-value pair, and at step 510, the method 500 will search for value texts whose centroids are above or below the key text for the desired key-value pair. For some printed documents, both steps 508 and 510 may be carried out for that printed document, for example where a printed document may have some key-value pairs that are horizontally aligned and some key-value pairs that are vertically aligned. After step 508 and/or 510, the method 500 then proceeds to step 512 to remove value texts that do not satisfy the particular key constraint(s) (e.g. where the value is expected to be a number, a non-numerical value text may be discarded). From step 512 the method 500 proceeds to step 514 and retrieves, from the remaining value texts for a given key-value pair, the value text whose centroid is closest to the centroid of the key text for that key-value pair. In some embodiments, step 512 may compare the vertical distance from the key text centroid to a vertically closest candidate text feature to the horizontal distance from the key text centroid to a horizontally closest candidate text feature, with optional weighting applied to one or both distances, to determine the value text. Optionally, a NULL value may be returned where the number of value texts removed at step 512 reaches a predetermined maximum value. The method then proceeds to optional step 516 to perform post-processing on the retrieved value text, such as removing extraneous characters, and then to step 518 to output the retrieved value text as a completed key-value pair.

Reference is now made to FIG. 5A, which is a flow chart showing a second non-limiting illustrative method 550 for applying a positional algorithm to implement steps 324 and 326. The method 550 begins at step 552 by finding the closest value text (a candidate text feature) to the key text (e.g. using the centroid method described above) and testing at step 554 whether that candidate text feature satisfies the key constraint(s). If this candidate text feature satisfies the key constraint(s) (“yes” at step 554), then at step 556 that candidate text feature is identified as the value of the key-value pair and the method 550 ends; otherwise (“no” at step 554) that candidate text feature is discarded at step 558 and the method 550 proceeds to step 560 to check whether a predetermined maximum number of candidate text features have been discarded. If the predetermined maximum number is reached (“yes” at step 560), at step 562 a “NULL” result is entered for the value of the key-value pair and the method 550 ends. If the predetermined maximum number has not yet been reached (“no” at step 560), the method 550 returns to step 552 to find the next closest candidate text feature, and then to step 554 to test that next closest candidate text feature. This process continues until either a candidate text feature satisfies the key constraint(s), or until a predetermined maximum number of candidate text features have been discarded. Thus, in such an embodiment a second text feature satisfies the proximity threshold and the key constraint(s) relative to the first text feature when the second text feature is proximal to the first text feature (step 552) and satisfies the key constraint(s) (step 554), and the number of discarded text features (step 558) that are proximal to the first text feature and closer to the first text feature than the second text feature is to the first text feature is less than the predetermined maximum (step 560). As noted, the discarded text features will have been discarded for failing to satisfy the at least one key constraint (steps 554 and 558). The method 550 may be applied in respect of vertical proximity of candidate text features to the key text, horizontal proximity of candidate text features to the key text, or proximity of candidate text features to the key text within a common boundary.

In another embodiment, instead of using a positional algorithm, a template-based approach can be used. As noted above, at step 308 the method 300 does not necessarily identify a specific type of structured form or template. However, a template can be used in implementing step 326, or in implementing both steps 324 and 326.

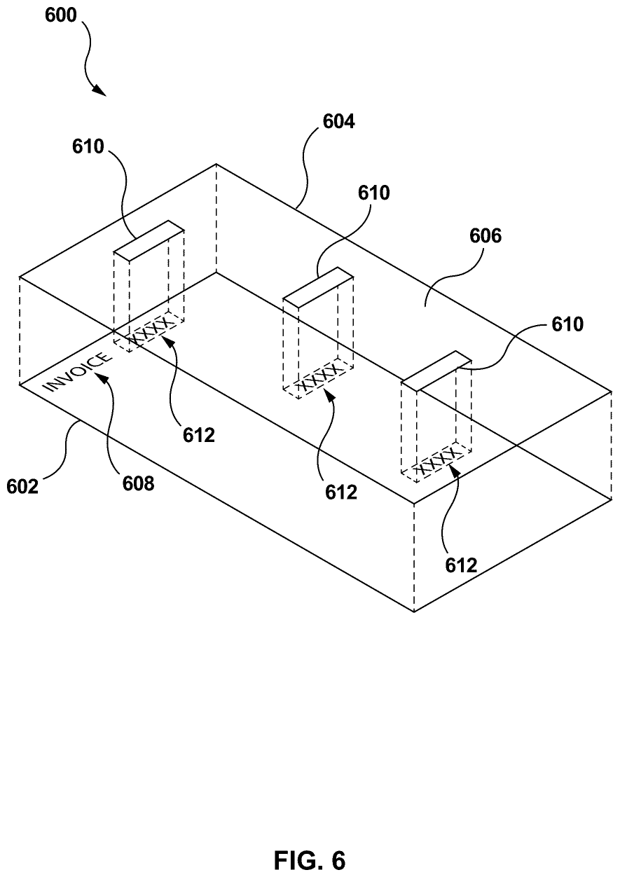

Reference is now made to FIG. 6, which schematically illustrates the use of a virtual template to identify a second text feature in the printed document that satisfies both a proximity threshold and one or more key constraints relative to the first text feature as the value of the key-value pair. To use the method shown in FIG. 6, a document type is identified for the printed document 602. This can be done, for example, by manually specifying the document type, or using a machine learning approach such as a trained classifier. In the illustrated embodiment the printed document 602 is an invoice, and may be identified not only as an invoice, but as an invoice from a specific company and having a specific format. A virtual document template 604 matching the document type is then identified. Thus, the virtual document template 604 would, in the illustrated example, match the specific format for an invoice from the specific company as identified for the printed document 602. The virtual document template 604 includes at least one opaque region 606 corresponding in position to one or more respective first text features 608, and one or more transparent regions 610, with each transparent region 610 corresponding in position with the expected location of a respective second text feature 612. Optionally the opaque region(s) 606 may have embedded text corresponding to the instance(s) of the first feature(s). The virtual document template 604 is then superimposed on the printed document 602 in alignment therewith, such that the opaque region(s) 606 will be in superposition with the respective first text feature(s) and the transparent region(s) 610 will be in superposition with the expected location(s) of the second text feature(s) 612 whereby the second text feature(s) will be unobscured by the virtual document template 604. The known location(s) of the transparent region(s) 610 can then be used to locate the second text feature(s) 612 from which the value(s) may be extracted. Thus, the second text feature satisfies the proximity threshold relative to the first text feature when the second text feature(s) 612 are within the respective transparent region(s) 610 and unobscured by the virtual document template 604. OCR may be performed on the entire printed document 602 before applying the virtual document template 604, or after applying the virtual document template 604, either on only the transparent region(s) 610 or the entire template-covered printed document, for example where the opaque region(s) 606 have embedded text corresponding to the instance(s) of the first feature(s).

Returning now to FIG. 3, at optional step 332, for at least some of the key-value pairs, the method 300 determines a confidence level for the value of the key-value pair. In one embodiment, a confidence level of “low”, “medium”, or “high” may be assigned to each key-value pair. Other confidence level gradations are also contemplated. Step 332 may comprise a series of sub-steps until all key-value pairs have been assigned a confidence level.

In a preferred embodiment, the confidence level for each key-value pair is assigned using one or more predetermined rule-based checks based on the format and context for the field type associated with that key-value pair. Some non-limiting examples will now be described. Some illustrative embodiments of the rule-based checks use SpaCy natural language processing tools, available at https://spacy.io/and incorporated herein by reference. These are merely non-limiting examples; other suitable tools and techniques may also be used.

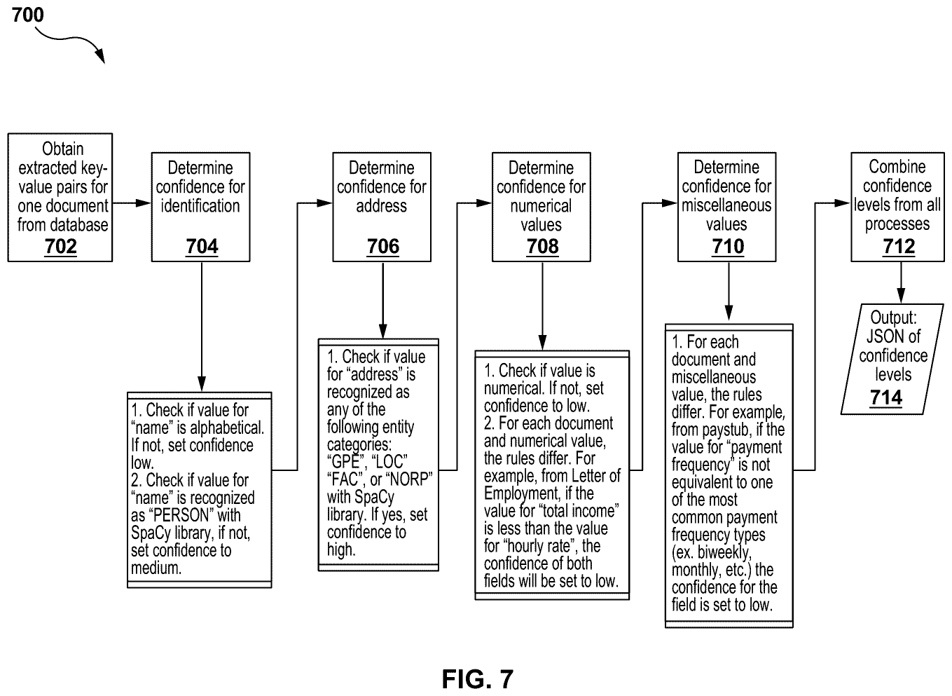

Reference is now made to FIG. 7, which is a flow chart showing a non-limiting illustrative method 700 for determining confidence levels for returned values for key-value pairs.

At step 702, the method 700 obtains extracted key-value pairs (e.g. resulting from the method 500 shown in FIG. 5) for one of the printed documents.

Optionally, if testing against the key constraint(s) has not yet been performed (e.g. at step 326), this testing may be performed as an initial step of the method 700, before proceeding to more substantive confidence checks. One example of testing against a key constraint is to confirm that the value does not contain any unexpected characters given the nature of the key. For example, a value of “80,229” for salary would satisfy the key constraint, because only numerical values are present. In contrast, a value of “H0,229” for salary would fail to satisfy the key constraint because the letter “H” is unexpected in the context of a salary. Similarly, for a “first name” key, “Homer” would satisfy the key constraint (all letters) but “8omer” would not. Of note, the key constraint test may be adjusted or omitted as required by the context if, for example, people begin to adopt names that include numeric characters.

At step 704, the method 700 determines a confidence level for values associated with identification of an individual, such as the name. For the name of an individual, the first name, middle name, and last name may be extracted individually, and string comparison may be performed on the values; the confidence level may be set to “low” if a name value includes non-alphabetic characters (e.g. “Regin@ld” or “Barclay”). Thus, in some embodiments, a confidence level test may be subsumed within a key constraint (e.g. non-alphabetic characters in a name). The confidence level may also be set to “low” if two name values are identical (e.g. if the first name and middle name are both “Reginald” or the middle name and last name are both “Barclay”). Additionally, the first name, middle name, and last name may be joined together and the SpaCy entity recognition functionality is applied to determine if the full name is recognized as a “PERSON”. If so, the confidence level for each name is set to “high”.

At step 706, the method 700 determines a confidence level for values associated with an address. The SpaCy entity recognition functionality may also be applied to the address to determine if the address is recognized under the category of “NORP” (nationalities), “FAC” (buildings, airports, highways, bridges), “GPE” (countries, cities, states), or “LOC” (non-GPE locations, mountain ranges, bodies of water). If the address is suitably recognized under the above categories, then the confidence level for address is set to “high”.

At step 708, the method 700 determines a confidence level for specific numerical values.

Date values may be subject to a range of checks, depending on the context. For example, where a date must by its nature be in the past, the dates can be checked to confirm that they are prior to the current date. For a paystub, values for “start pay period” and “end pay period” may be checked to ensure that “start pay period” is before “end pay period”. Dates can also be checked for fundamental validity; a “day” value above 31, or a month value above 12, would fail such a fundamental validity check. If any of the checks are failed, then the confidence level for that date may be set to “low”.

Monetary values can be checked against certain contextual rules relative to other monetary values on the document. For example, an hourly wage must always be lower than annual income, if it is not then the confidence level for both fields is set to “low”. In addition, a currency denomination can be checked against the most common currencies encountered in the relevant jurisdiction (e.g. in Canada this would be CAD, USD, and EURO). If the extracted currency is not within the list of most common currencies, then the confidence level may be set to “low”.

At step 710, the method 700 determines a confidence level for miscellaneous values. For example, if the printed document is a paystub, the payment frequency value can be compared to common values, such as weekly, bi-weekly, semi-monthly, or monthly. Other methods may be used for determining the confidence levels for other miscellaneous key-value pairs. Where a value is NULL, it can be assigned “low” confidence by default.

At step 712, the confidence levels from all processes are combined, and the output at step 714 is a JSON file that includes the confidence levels. Where the value of a key-value pair has “medium” or “low” confidence, a user may be prompted to manually input the value for that field to provide for risk mitigation.

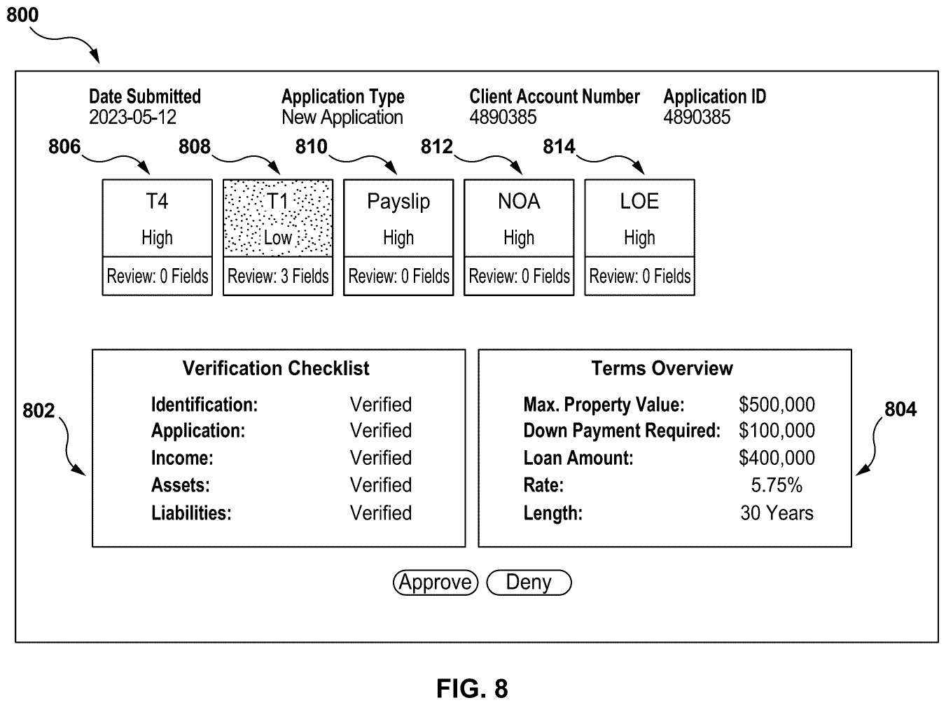

Reference is now made to FIG. 8, which shows a first screen 800 of an illustrative user interface for a system according to an aspect of the present disclosure used in the context of a financial institution. Depending on the line of business and use case, verification of the information provided by the client or other document submitter may be required. In this case, for each document submitted by the client, the required information (data fields) provided by the client are compared against the values of the key-value pairs corresponding to those fields automatically extracted by the system.

The first screen 800 shows, by way of non-limiting illustration, an overview of automated document review and verification by the system in the context of a Canadian mortgage application, it being understood that the system may be adapted to a wide range of applications (both financial and non-financial) and jurisdictions. A “Verification Checklist” box 802 shows that the client's identification, application, income, assets, and liabilities have been verified. A “Terms Overview” box 804 shows the terms of the mortgage loan. The listed mortgage rate is illustrative and no financial forecast or lending offer is implied. Similarly the loan amount and property value are arbitrary illustrative values. A series of document confidence boxes show whether, for any of the printed documents ingested by the system, manual review of values (fields) is required (e.g. because of a “low” or “medium” confidence level). The document confidence boxes include a T4 confidence box 806, a T1 confidence box 808, a payslip confidence box 810, a Notice of Assessment (NOA) confidence box 812, and a letter of employment (LOE) confidence box 814. Form T4 is the Canadian tax form for reporting by an employer of employment income, Form T1 is the Canadian tax form used by individuals to file their personal income tax return, and a NOA is the official evaluation of the tax return sent to the taxpayer by the Canada Revenue Agency (analogous to the United States Internal Revenue Service) after the tax return has been processed.

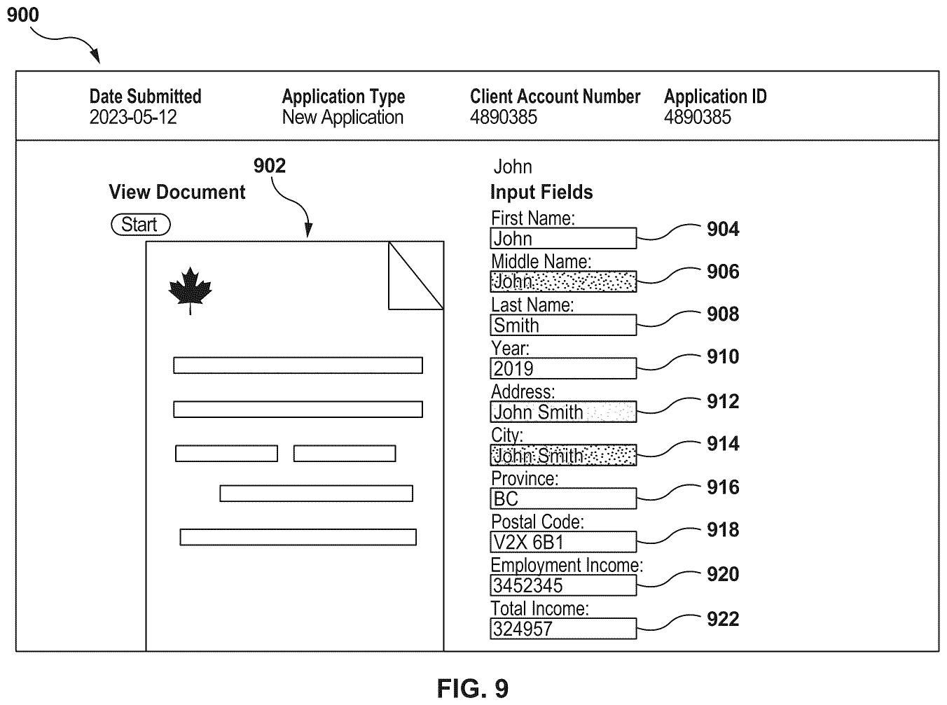

In FIG. 8, the T4 confidence box 806, payslip confidence box 810, NOA confidence box 812 and LOE confidence box 814 show high confidence, and may be displayed with a suitable corresponding color such as green (no dot shading in the drawings, which do not permit color) to show that none of the values (fields) require review. However, the T1 confidence box 808 shows low confidence, and may be displayed with a suitable corresponding color such as red (dark dot shading in the drawings, which do not permit color) to show that one or more fields require review; in this case three (3) fields require review. By selecting (e.g. by mouse click) the T1 confidence box 808, the user can initiate a second screen 900 of the illustrative user interface, as shown in FIG. 9.

The second screen 900 displays a document image 902 of the Form T1 document (shown symbolically rather than an actual reproduction) as ingested by the system, and to the right of the document image 902 a series of field value boxes display the values of the key-value pairs extracted for the relevant fields. These include a “First Name” box 904, a “Middle Name” box 906, a “Last Name” box 908, a “Year” box 910, an “Address” (street address) box 912, a “City” box 914, a “Province” box 916, a “Postal Code” box 918, an “Employment Income” box 920, and a “Total Income” box 922. The data shown does not represent any real person, living or dead, or any fictitious character, but is merely placeholder data for purposes of illustration. The field value boxes 904 to 922 provide an indication of the confidence level assigned to the value; this may be done, for example and without limitation, by color, highlighting, or text (e.g. “low”, “medium” or “high” below or beside the respective field value box). In the illustrated embodiment the indication of the confidence level is provided by way of color (shown with dot shading as the drawings do not permit color). On the illustrative second screen 900 the “Middle Name” box 906 and the “City” box 914 would be displayed in red (darker dot shading in the drawings, which do not permit color) indicating low confidence and the “Address” box 912 is displayed in yellow (lighter dot shading in the drawings, which do not permit color), indicating medium confidence. The remaining field value boxes 904, 908, 910, and 914 to 922 are displayed in green (no dot shading in the drawings, which do not permit color), indicating high confidence. The user can then manually edit these fields, based on a review of the document image 902. Optionally, locations on the document image 902 corresponding to the field value boxes having low or medium confidence may be highlighted.

A user of a system according to an aspect of the present disclosure may include a staff member, such as a bank employee or human resources employee, and an administrator. A staff member may use the system to select an application, review confidence scores for each document in the application, manually input data (e.g. for fields with low or medium confidence), check data verification from the documents against the application, review the application and approve or deny the application.

An administrator may be able to perform any of the functions of a staff member, and in addition perform higher-level administrative functions. For example, an administrator may be able to view internal reporting, such as average confidence level, average time for application review, number of manual interventions required for different document types, etc. An administrator may also be able to alter functionality of the system. For example, an administrator may be able to change the LLM used or add an additional LLM—in some cases, different LLMs may be used for different types of printed documents or different key-value pairs, depending on performance. An administrator may also be permitted to add new types of printed documents to the system, including naming of the new printed document, assigning the new printed document to one or more different types of application (including creating new application types), marking the new printed document as structured (including fully structured and semi-structured, or unstructured), and selecting the fields for which key-value pairs are to be extracted from the new printed document.

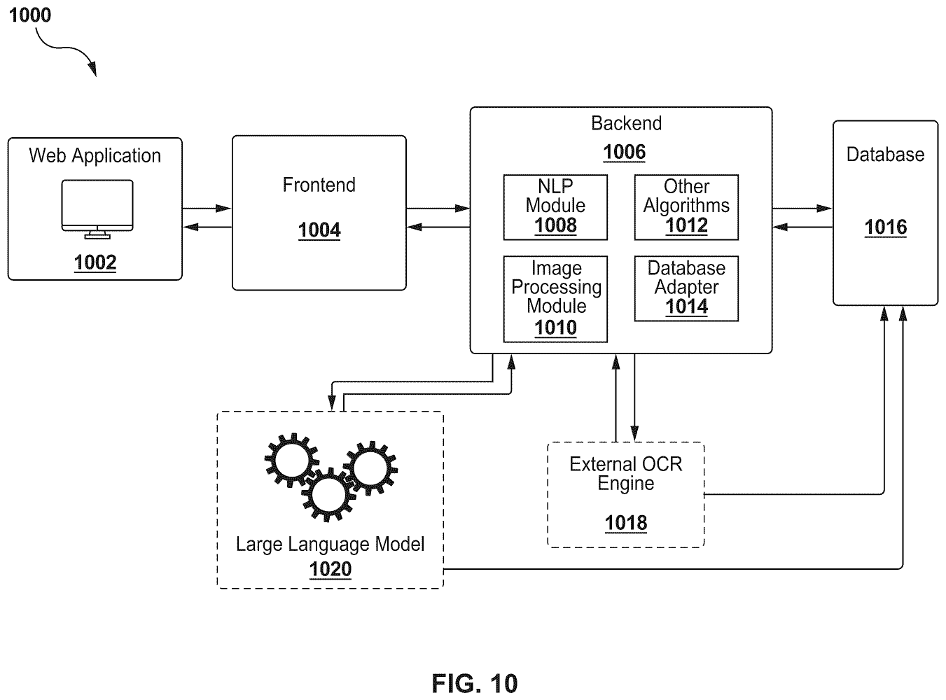

Reference is now made to FIG. 10, which shows a non-limiting illustrative technical architecture 1000 for an implementation of a system according to an aspect of the present disclosure.

The system 1000 may be accessed using a web application 1002, supported by a frontend 1004. The frontend 1004 may be implemented using the React JavaScript Library (https://react.dev/) for example. The backend 1006 may be implemented using the Flask web framework (https://flask.palletsprojects.com/en/3.0.x/) with Python, and includes a natural language programming (NLP) module 1008, which may incorporate components of the SpaCy library, an image processing module 1010, which may include components of the OpenCV computer vision library, as well as other algorithms 1012, which may be implemented using Jupyter Notebook (https://jupyter.org/), for example. The backend 1006 communicates, by way of a database adaptor 1014, with a database 1016. The database 1016 may be a PostgreSQL database and the database adaptor 1014 may be a Psycopg2 database adaptor (https://pypi.org/project/psycopg2/), for example. The backend 1006 communicates with an external OCR engine 1018, for example via the Azure Read API, and with an external LLM 1020, such as the Falcon 40B LLM deployed on Amazon SageMaker.

Preferably, the backend 1006 is configured to be agnostic as to the particular LLM used so that the LLM 1020 is “plug-and-play”, allowing the LLM to be changed with little or no modification. The LLM would function as a “black box”, and as long as the LLM is well constructed, suitably engineered prompts should elicit satisfactory output from any suitable well-built LLM. The use of image segmentation and prompt engineering allows the use of general LLMs, mitigating the requirement to train LLMs on specific documents and to procure substantial amounts of financial data to train the LLM. One current embodiment uses the Falcon 40B LLM as noted above, but this can be exchanged with other hosted LLMs. Switching of LLMs has been tested successfully by substituting the ChatGPT 3.5 LLM, offered by Open AI (https://openai.com/), having an address at 3180 18th Street, San Francisco, California 94110, for the Falcon 40B LLM.

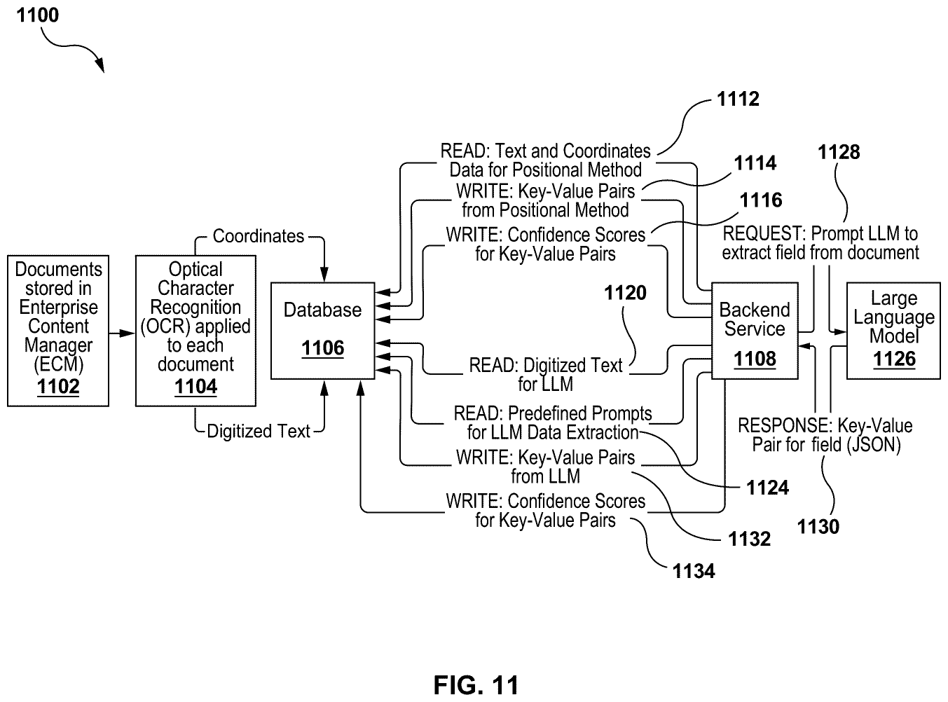

FIG. 11 shows an illustrative, non-limiting system data flow diagram for a system according to an aspect of the present disclosure. Printed documents are submitted to an Enterprise Content Manager (ECM) system at block 1102 in the form of scanned PDF documents. At block 1104, OCR is applied to each printed document and each printed document is converted into digitized text, for example through a call to the Azure Read API; coordinates for the text are also obtained. The path to the JSON format of the printed document generated from the Azure Read API is stored in a database 1106 (e.g. a PostgreSQL database), along with the type of document and other information (e.g. in the case of an application for a loan, the type of loan application may be stored; in the case of a job application, the position applied for may be stored). Depending on the printed document type and the other information (e.g. application type), a list of predefined fields required from the printed document will also be stored in the database 1106.

To trigger the data extraction flow, a Hypertext Transfer Protocol (HTTP) GET request (used to request data from a specified resource) is sent (e.g. from the web application 1002 supported by the frontend 1004 in FIG. 10) to a data extraction Representational State Transfer (REST) API on the backend 1108. The request payload includes the document type and the unique ID required to retrieve the JSON version of the printed document from the database 1106. Depending on the type of printed document, either a positional algorithm, a LLM query, or a hybrid of those two methods will be applied to extract key-value pairs from the printed document. The method applied may be predefined depending on the document type, or may be determined on an ad hoc basis. If the LLM is used to extract data from the printed document, predefined prompts corresponding to the various types of printed document and the fields for which key-value pairs are needed may be stored in the database 1106 and used to generate output from the LLM.

For the positional algorithm, the backend 1108 will read the text and coordinate data from the database 1106 at data flow 1112, then extract the values for the key-value pairs using the positional method and calculate corresponding confidence scores. The backend 1108 writes the extracted key-value pairs to the database 1106 at data flow 1114, and writes the confidence scores to the database 1106 at data flow 1116.

For the LLM approach, the backend 1108 will read the digitized text from the database 1106 at data flow 1120, then read one or more predefined LLM prompts at data flow 1124. The text and prompt(s) are then sent to an external LLM 1126 at data flow 1128. The key-value pair(s) are received at the backend 1108 from the LLM 1126 at data flow 1130. The backend 1108 calculates the confidence score(s), and writes the key-value pair(s) to the database 1106 at data flow 1132, and writes the confidence scores to the database 1106 at data flow 1134.

The key-value pairs are stored in the database 1106 along with the document type for the printed document, a client ID, and an application ID (if applicable).

As can be seen from the above description, the technology described herein represents significantly more than merely using categories to organize, store and transmit information and organizing information through mathematical correlations. The technology is in fact an improvement to digital ingestion of printed documents, as it provides tailored handling of form data by using different approaches for structured forms and unstructured forms. This facilitates the benefit of a more generalized handling of printed documents to extract data therefrom. Consequently, the technology described herein is confined to computer-implemented document ingestion and data extraction applications.

The processor used in the foregoing embodiments may comprise, for example, a processing unit (such as a processor, microprocessor, or programmable logic controller) or a microcontroller (which comprises both a processing unit and a non-transitory computer readable medium). Examples of computer readable media that are non-transitory include disc-based media such as CD-ROMs and DVDs, magnetic media such as hard drives and other forms of magnetic disk storage, semiconductor based media such as flash media, random access memory (including DRAM and SRAM), and read only memory. As an alternative to an implementation that relies on processor-executed computer program code, a hardware-based implementation may be used. For example, an application-specific integrated circuit (ASIC), field programmable gate array (FPGA), system-on-a-chip (SoC), or other suitable type of hardware implementation may be used as an alternative to or to supplement an implementation that relies primarily on a processor executing computer program code stored on a computer medium.

The embodiments have been described above with reference to flow, sequence, and block diagrams of methods, apparatuses, systems, and computer program products. In this regard, the depicted flow, sequence, and block diagrams illustrate the architecture, functionality, and operation of implementations of various embodiments. For instance, each block of the flow and block diagrams and operation in the sequence diagrams may represent a module, segment, or portion of code, which comprises one or more executable instructions for implementing the specified action(s). In some alternative embodiments, the action(s) noted in that block or operation may occur out of the order noted in those figures. For example, two blocks or operations shown in succession may, in some embodiments, be executed substantially concurrently, or the blocks or operations may sometimes be executed in the reverse order, depending upon the functionality involved. Some specific examples of the foregoing have been noted above but those noted examples are not necessarily the only examples. Each block of the flow and block diagrams and operation of the sequence diagrams, and combinations of those blocks and operations, may be implemented by special purpose hardware-based systems that perform the specified functions or acts, or combinations of special purpose hardware and computer instructions.

The terminology used herein is for the purpose of describing particular embodiments only and is not intended to be limiting. Accordingly, as used herein, the singular forms “a”, “an”, and “the” are intended to include the plural forms as well, unless the context clearly indicates otherwise (e.g., a reference in the claims to “a training data set” or “the training data set” does not exclude embodiments in which multiple training data sets are used). It will be further understood that the terms “comprises” and “comprising”, when used in this specification, specify the presence of one or more stated features, integers, steps, operations, elements, and components, but do not preclude the presence or addition of one or more other features, integers, steps, operations, elements, components, and groups. Directional terms such as “top”, “bottom”, “upwards”, “downwards”, “vertically”, and “laterally” are used in the following description for the purpose of providing relative reference only, and are not intended to suggest any limitations on how any article is to be positioned during use, or to be mounted in an assembly or relative to an environment. Additionally, the term “connect” and variants of it such as “connected”, “connects”, and “connecting” as used in this description are intended to include indirect and direct connections unless otherwise indicated. For example, if a first device is connected to a second device, that coupling may be through a direct connection or through an indirect connection via other devices and connections. Similarly, if the first device is communicatively connected to the second device, communication may be through a direct connection or through an indirect connection via other devices and connections. The term “and/or” as used herein in conjunction with a list means any one or more items from that list. For example, “A, B, and/or C” means “any one or more of A, B, and C”.

It is contemplated that any part of any aspect or embodiment discussed in this specification can be implemented or combined with any part of any other aspect or embodiment discussed in this specification.

The scope of the claims should not be limited by the embodiments set forth in the above examples, but should be given the broadest interpretation consistent with the description as a whole.

It should be recognized that features and aspects of the various examples provided above can be combined into further examples that also fall within the scope of the present disclosure. In addition, the figures are not to scale and may have size and shape exaggerated for illustrative purposes.

One or more currently preferred embodiments have been described by way of example. It will be apparent to persons skilled in the art that a number of variations and modifications can be made without departing from the scope of the invention as defined in the claims.

What is claimed is:

1. A computer-implemented method for extracting data from printed documents, the method comprising:
receiving a printed document;
identifying the printed document as one of a structured form and an unstructured form;
where the printed document is identified as a structured form, identifying a first text feature within the printed document corresponding to a key for a key-value pair;
identifying, as a value of the key-value pair, a second text feature within the printed document that satisfies both:
a proximity threshold relative to the first text feature; and
at least one key constraint relative to the first text feature; and
recording the value of the key-value pair.

2. The method of claim 1, further comprising determining a confidence level for the value of the key-value pair.

3. The method of claim 1, wherein the second text feature satisfies the proximity threshold and the at least one key constraint relative to the first text feature when:
the second text feature is horizontally proximal to the first text feature;
the second text feature satisfies the at least one key constraint; and
a number of discarded text features that are horizontally proximal to the first text feature and closer to the first text feature than the second text feature is to the first text feature is less than a predetermined maximum;
wherein the discarded text features were discarded for failing to satisfy the at least one key constraint.

4. The method of claim 1, wherein the second text feature satisfies the proximity threshold and the at least one key constraint relative to the first text feature when:
the second text feature is vertically proximal to the first text feature;
the second text feature satisfies the at least one key constraint; and
a number of discarded text features that are vertically proximal to the first text feature and closer to the first text feature than the second text feature is to the first text feature is less than a predetermined maximum;
wherein the discarded text features were discarded for failing to satisfy the at least one key constraint.

5. The method of claim 1, wherein the second text feature satisfies the proximity threshold and the at least one key constraint relative to the first text feature when:
the second text feature is within a common boundary with the first text feature;
the second text feature satisfies the at least one key constraint; and
a number of discarded text features that are within the common boundary with the first text feature and closer to the first text feature than the second text feature is to the first text feature is less than a predetermined maximum;
wherein the discarded text features were discarded for failing to satisfy the at least one key constraint.

6. The method of claim 1, further comprising, prior to identifying the second text feature, performing optical character recognition (OCR) on at least a portion of the printed document.

7. The method of claim 6, wherein performing OCR on at least a portion of the printed document is carried out prior to identifying the first text feature.

8. The method of claim 1, further comprising, prior to identifying the second text feature:
identifying a document type for the printed document;
superimposing a virtual document template matching the document type on the printed document, wherein the virtual document template includes:
an opaque region corresponding at least to the first text feature, wherein the opaque region is in superposition with the first text feature; and
a transparent region, wherein the transparent region is in superposition with an expected location of the second text feature;
wherein the second text feature satisfies the proximity threshold relative to the first text feature when the second text feature is within the transparent region and is unobscured by the virtual document template.

9. The method of claim 8, further comprising, prior to identifying the second text feature, performing OCR on at least a portion of the printed document to identify characters of the second text feature.

10. The method of claim 1, further comprising:
responsive to identifying the printed document as an unstructured form, applying a trained machine learning model to content of the printed document to extract the value for the key-value pair.

11. The method of claim 10, wherein the trained machine learning model is a large language model.

12. The method of claim 10, wherein the content of the printed document is obtained by, prior to applying the trained machine learning model, performing OCR on at least a portion of the printed document.

13. The method of claim 1, further comprising:
responsive to identifying the printed document as a structured form, identifying the printed document as one of a fully structured form or a semi-structured form;
responsive to identifying the printed document as a semi-structured form, identifying at least one unstructured portion of the printed document; and
applying a trained machine learning model to the unstructured portion of the printed document.

14. A computer program product comprising at least one tangible non-transitory computer readable medium embodying instructions which, when executed by at least one processor of a data processing system, cause the data processing system to carry out the method of claim 1.

15. A data processing system comprising memory and at least one processor coupled to the memory wherein the memory stores instructions which, when executed by the at least one processor, cause the data processing system to carry out the method of claim 1.

16. A computer-implemented method for extracting data from printed documents, the method comprising:
receiving a printed document;
identifying the printed document as one of a structured form and an unstructured form;
where the printed document is identified as a structured form, identifying a first text feature within the printed document corresponding to a key for a key-value pair;
identifying, as a potential value of the key-value pair, a second text feature within the printed document that satisfies a proximity threshold relative to the first text feature; and
recording the potential value of the key-value pair.

17. The method of claim 16, wherein the proximity threshold is that the second text feature is one of a plurality of candidate text features that is closest to the first text feature.

18. The method of claim 16, wherein the second text feature is identified as the potential value of the key-value pair solely because the second text feature satisfies the proximity threshold.

19. The method of claim 16, wherein the second text feature is identified as the potential value of the key-value pair because the second text feature is a closest one of a plurality of candidate text features that satisfies at least one key constraint.

20. A computer program product comprising at least one tangible non-transitory computer readable medium embodying instructions which, when executed by at least one processor of a data processing system, cause the data processing system to carry out the method of claim 16.

21. A data processing system comprising memory and at least one processor coupled to the memory wherein the memory stores instructions which, when executed by the at least one processor, cause the data processing system to carry out the method of claim 16.
